(19) United States
(12) Patent Application Publication
(10) Pub. No.: US 2026/0080267 A1
(43) Pub. Date: Mar. 19, 2026

(54) SEARCH TREE PRUNING DEVICE AND METHOD FOR AUTOMATED PLANNING SYSTEM

(71) Applicant: ELECTRONICS AND TELECOMMUNICATIONS RESEARCH INSTITUTE, Daejeon (KR)

(72) Inventor: Joon Myun CHO, Daejeon (KR)

(73) Assignee: ELECTRONICS AND TELECOMMUNICATIONS RESEARCH INSTITUTE, Daejeon (KR)

(21) Appl. No.: 19/309,767

(22) Filed: Aug. 26, 2025

(30) Foreign Application Priority Data
Sep. 13, 2024 (KR) 10-2024-0125765

(51) Int. Cl. G06N 5/01

(52) U.S. Cl. CPC G06N 5/01

(57) ABSTRACT

Disclosed are a search tree pruning device and method for an automated planning system. The search tree pruning device for an automated planning system of the present invention includes a processor, and a memory configured to store instructions executed by the processor, wherein the processor selects a current action node from among front nodes of a search tree in an action space to execute an action of the current action node, and adds a new action node as a sub-node of the current action node according to whether the new action node has a preset causal involvement with the current action node.

### CROSS-REFERENCE TO RELATED APPLICATION

This application claims priority to and the benefit of Korean Patent Application No. 10-2024-0125765, filed on Sep. 13, 2024, the disclosure of which is incorporated herein by reference in its entirety.

### BACKGROUND

### 1. Field of the Invention

The present invention relates to a search tree pruning device and method for an automated planning system.

### 2. Discussion of Related Art

Autonomous objects, such as intelligent robots, autonomous cars, etc., are devices, apparatuses, or systems that achieve goals (missions) given by users or the like in their current situation (state) without human intervention. Among various methods of implementing such autonomous objects, there is a method of automatically generating a plan (hereinafter referred to as an “action plan”) consisting of a series of actions that should be executed to complete a goal (mission) and executing the generated plan to achieve a given mission.

An action plan is a sequence of actions that should be executed to achieve a given mission, that is, to succeed in the given mission. Here, an action is a unit operation of an autonomous object on its environment that changes a state of the environment. In other words, mission completion (success) corresponds to an autonomous object changing (transitioning) a current state of an environment to a state when the mission is completed, that is, a target state, through execution of a series of missions, and the action plan corresponds to a sequence of actions included on a path of the environmental state transition.

Among technologies in which autonomous objects generate their own action plans, in the conventional technology known as automated planning or AI planning, an action plan is generated by constructing a search tree in a state space in which possible states of an environment and transitions between the states are represented as nodes and edges, respectively.

The construction of the search tree in the state space is a process of sequentially expanding related intermediate nodes starting from a root node or initial node representing a current state until reaching a leaf node or target node corresponding to a target state. Therefore, the performance of an action planning system depends on how rapidly it finds branches leading to the target node or how rapidly it prunes branches that do not lead to the target node, when expanding a search tree. In short, it is necessary to rapidly filter out intermediate state nodes that are unrelated to the target node.

The related art of the present invention is disclosed in Korean Patent Registration No. 10-1684423 (Published on Dec. 2, 2016).

### SUMMARY OF THE INVENTION

The present invention is directed to providing a search tree pruning device and method for an automated planning system that can construct a search tree in an action space and prune the search tree using a causal involvement between actions when expanding the search tree, thereby reducing a search space.

According to an aspect of the present invention, there is provided a search tree pruning device for an automated planning system, which includes a processor, and a memory configured to store instructions executed by the processor, wherein the processor selects a current action node from among front nodes of a search tree in an action space to execute an action of the current action node, and adds a new action node as a sub-node of the current action node according to whether the new action node has a preset causal involvement with the current action node.

The processor of the present invention may select one of the front nodes of the search tree to execute an action, find a new executable action node in a state in which the action of the current action node is executed, add the new executable action node as the sub-node of the current action node, and check whether the state in which the action of the added new action node is executed is a target state to generate the search tree.

The processor of the present invention may determine the causal involvement between the current action node and the new action node on a causal action network.

The hierarchical structure of the causal action network of the present invention may be formed in such a way that actions that have a causal relation with actions belonging to one layer form a next layer.

The processor of the present invention may write the causal action network using actions that are instantiated by substituting symbols representing entity knowledge stored in a knowledge base for variables of action schemas.

The processor of the present invention may determine whether the new action node has a causal involvement with the current action node on the basis of whether the new action node is directly or indirectly connected to a path through which the target action node is connected to the current action node in the causal action network.

The processor of the present invention may determine that the new action node has a causal involvement with the current action node when the new action node is at a level that is one level lower than or the same level as the current action node and the new action node is a node subsequent to the current action node on the path between the current action node and the target action node.

The processor of the present invention may determine that the new action node has a causal involvement with the current action node when the new action node is connected to a subsequent action node at a level that is one level lower than the current action node or when the new action node is connected to a subsequent action node that is at the same level as the current action node.

The processor of the present invention may determine that the new action node has a causal involvement with the current action node when the subsequent action node is at a level that is one level lower than the current action node and the new action node is connected to the current action node through another action node that is at the same level as the subsequent action node, or when the subsequent action node is at the same level as the current action node and the new action node is connected to the current action node through another node that is at the same level as the subsequent action node.

According to another aspect of the present invention, there is provided a search tree pruning method for an automated planning system, which includes selecting, by a processor, a current action node from among front nodes of a search tree in an action space to execute an action of the current action node, and determining whether a new action node has a preset causal involvement with the current action node, and adding, by the processor, the new action node as a sub-node of the current action node according to a result of the determination.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram of a search tree pruning device for an automated planning system according to one embodiment of the present invention;

FIG. 2 is a flowchart of a search tree pruning method for an automated planning system according to one embodiment of the present invention;

FIG. 3 is a causal action network showing a case in which a new action node has a direct causal relationship with a current action node and is at a level that is one level lower than the current action node according to one embodiment of the present invention;

FIG. 4 is a causal action network showing a case in which a new action node has a direct causal relationship with a current action node and is at the same level as the current action node according to one embodiment of the present invention;

FIG. 5 is a causal action network showing a case in which a new action node is connected to a subsequent action node at a level that is one level lower than a current action node according to one embodiment of the present invention;

FIG. 6 is a causal action network showing a case in which a new action node is connected to a subsequent action node that is at the same level as a current action node according to one embodiment of the present invention;

FIG. 7 is a causal action network showing a case in which a subsequent action node is at a level that is one level lower than a current action node and a new action node is connected to the current action node through another node that is at the same level as the subsequent action node according to one embodiment of the present invention; and

FIG. 8 is a causal action network showing a case in which a subsequent action node is at the same level as a current action node and a new action node is connected to the current action node through another node that is at the same level as the subsequent action node according to one embodiment of the present invention.

### DETAILED DESCRIPTION OF EXEMPLARY EMBODIMENTS

Hereinafter, examples of a search tree pruning device and method for an automated planning system according to embodiments of the present invention will be described. In this process, thicknesses of lines, sizes of components, and the like illustrated in the drawings may be exaggerated for clarity and convenience of description. Further, some terms which will be described below are defined in consideration of functions in the present invention and meanings may vary depending on, for example, a user or operator's intentions or customs. Therefore, the meanings of these terms should be interpreted based on the scope throughout this specification.

Embodiments of the present invention may be implemented in several different forms and are not limited to embodiments described herein. In addition, parts irrelevant to description are omitted in the drawings in order to clearly explain the present invention. Similar parts are denoted by similar reference numerals throughout this specification.

Throughout this specification, when a portion “includes” an element, another element may be further included, rather than excluding the presence of other elements, unless otherwise described.

The implementations described herein may be conducted, for example, as a method or process, a device, a software program, a data stream, or signals. Even when discussed only in the context of a single form of implementation (e.g., discussed only as a method), the implementation of the features discussed may also be conducted in other forms (e.g., as a device or a program). A device may be implemented as appropriate hardware, software, firmware, etc. A method may be implemented in a device, such as a processor, which generally refers to a processing device including, for example, a computer, a microprocessor, an integrated circuit, a programmable logic device, or the like.

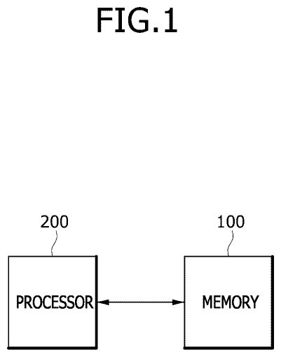

FIG. 1 is a block diagram of a search tree pruning device for an automated planning system according to one embodiment of the present invention.

Referring to FIG. 1, the search tree pruning device for an automated planning system according to one embodiment of the present invention may include a memory 100 and a processor 200.

The memory 100 may store various data used by the processor 200. The data may include instructions for performing operations or steps according to the embodiment of the present invention. That is, the memory 100 may store instructions, which construct a search tree in an action space and prune the search tree using a causal involvement between actions when expanding the search tree, to reduce a search space.

The memory 100 may include at least one storage medium among a flash memory type storage medium, a hard disk type storage medium, a multimedia card micro type storage medium, a card type memory, a random access memory (RAM), a static random access memory (SRAM), a read-only memory (ROM), a programmable read-only memory (PROM), an erasable programmable read-only memory (EPROM), and an electrically erasable programmable read-only memory (EEPROM).

The processor 200 may be connected to the memory 100 and execute the instructions stored in the memory 100. The processor 200 may execute the instructions stored in the memory 100 to control at least one (e.g., hardware or software component) of other components connected to the processor 200 and perform various data processing or operations.

Further the processor 200 may include components for performing each function by being divided on a hardware, software, or logic level. In this case, dedicated hardware may be used to perform each function. To this end, the processor 200 may be implemented as at least one of application specific integrated circuits (ASICs), a digital signal processor (DSP), programmable logic devices (PLD), field programmable gate arrays (FPGAs), a central processing unit (CPU), microcontrollers, and/or microprocessors, or may include at least one of them.

The processor 200 may be implemented as a CPU or a system on a chip (SoC), drive an operating system or an application to control a plurality of hardware or software components connected to the processor 200, and perform various data processing and operations. The processor 200 may be configured to execute at least one command stored in the memory 100 and store result data of the execution in the memory 100.

The processor 200 may construct the search tree in the action space.

The processor 200 may select one of front nodes of the search tree in the action space (hereinafter referred to as a “current action node”) and add only those nodes among the expanded nodes (hereinafter referred to as “new action nodes”) that have a causal involvement with the current action node as sub-nodes of the current action node, that is, add only those nodes to a front.

The front nodes may be a set of all leaf nodes at one time point among the components of the search tree, i.e., nodes having no sub-nodes. The front nodes may be candidates for nodes to be expanded at a next time point.

The search tree constructed in the action space may have nodes representing actions and connections (edges) between the nodes representing states.

A root node of the search tree in the action space may be a virtual action node that derives an initial state, that is, a post-condition thereof is the initial state.

A target action node of the search tree in the action space may be a node corresponding to a virtual action that has a target state as a pre-condition.

The processor 200 may, in order to construct the search tree in the action space, first select one of the front nodes of the search tree in the action space to execute a corresponding action, secondly find a new executable action node in a state in which the action of the selected current action node is executed, thirdly add the new action node as a sub-node of the current action node, and fourthly check whether the state in which the action of the added new action node is executed is the target state.

When the new executable action node in the second step of the above process is added as the sub-node of the current action node in the third step, the processor 200 may check a causal involvement between the current action node and the new action node, and add only the new action node having the causal involvement as the sub-node of the current action node in the third step.

As used herein, the term “causal involvement” refers to a structural and directional relationship between a “current action node” and a “new action node” within a preconstructed causal action network. Specifically, a new action node is said to have causal involvement with the current action node if any of the following holds:
(1) The new action node appears as a direct descendant of the current node in the causal action network (i.e., one level lower and directly linked).
(2) The new action node is a sibling-level successor on a causal path to the target action node.
(3) The new action node is connected to a subsequent node via intermediary nodes that are logically aligned within one or two same-level expansions, based on a bounded depth.

Such involvement is determined based on pre- and post-condition overlaps and the existence of directional causal links in the network structure.

The processor 200 may check the causal involvement between the current action node and the new action node as follows.

The processor 200 may use a data structure called a causal action network.

A causal relation between two actions is a directional relation, and when some post-conditions of action A match some pre-conditions of action B, it can be said that there is a causal relation from action B to action A. The causal action network may have a structure in which such a causal relation is found for all possible actions starting from the target action node and the actions that have the causal relation are hierarchically connected.

A hierarchical structure of the causal action network is formed in such a way that actions that have a causal relation with actions in one layer form a next layer. An action that appears (registers) in the causal action network even once is excluded from a “target action set” for finding actions that have a causal relation, so that the causal action network has a hierarchical structure, and one action does not appear multiple times.

Actions (nodes) required to construct the causal action network, that is, “all possible actions,” may be generated using entity knowledge and action schemas that are pre-stored in a knowledge base. This is because by substituting the entity knowledge stored in the knowledge base, that is, symbols representing entities, for variables of the action schemas to instantiate the actions, it is possible to generate all possible actions in a corresponding domain in advance.

As a result, the processor only needs to generate the causal action network once, at the beginning of an action plan. For example, given a target state (a set of multiple atomic statements or literals) from a user, the processor constructs a level 1 hierarchy by finding an action of which one post-condition (a set of multiple atomic statements or literals) matches part of the target state among all possible actions. The processor may construct a level 2 hierarchy by finding action nodes that have a causal relation with level 1 action nodes from a set of “all possible actions” excluding actions that appear in the level 1 hierarchy. The processor may construct a level 3 hierarchy by finding a set of “all possible actions,” excluding the action nodes in the level 1 and 2 hierarchy, that have a causal relation with the action nodes in the level 2 hierarchy. The processor may repeat the above process until the set of “all possible actions” nodes is empty or no more specific action nodes with the causal relation can be found.

The processor may write a symbolic model (knowledge base) that describes (represents/stores) information on an action plan target domain (current state of an environment, actions and their pre-conditions and post-conditions (effects), and target state).

The knowledge base may be written before the execution of an action plan generation algorithm begins and input to the action plan generation algorithm.

More specifically, the initial state of the environment and the target state corresponding to the completion of a given mission may be stored as a combination (connection) of atomic sentences or literals of first-order logic expressing unit information. Further, the pre-conditions and post-conditions for each action may be stored in the form of a schema or template by introducing variables whose values are symbols representing objects in a predefined environment (hereinafter referred to as the “action schema”).

For example, an automatic action planning problem for a mission that involves transporting two loads of cargo to two airports by two cargo planes (airplanes) may be considered. Below is an example of a knowledge base written and stored for the above problem.

```
Init(At(C₁, SFO) ∧ At(C₂, JFK) ∧ At(P₁, SFO) ∧ At(P₂, JFK)
    ∧ Cargo(C₁) ∧ Cargo(C₂) ∧ Plane(P₁) ∧ Plane(P₂)
    ∧ Airport(JFK) ∧ Airport(SFO))
Goal(At(C₁, JFK) ∧ At(C₂, SFO))
Action(Load(c, p, a),
  PRECOND: At(c, a) ∧ At(p, a) ∧ Cargo(c) ∧ Plane(p) ∧ Airport(a)
  EFFECT: - At(c, a) ∧ In(c, p))
Action(Unload(c, p, a),
  PRECOND: In(c, p) ∧ At(p, a) ∧ Cargo(c) ∧ Plane(p) ∧ Airport(a)
  EFFECT: At(c, a) ∧ - In(c, p))
Action(Fly(p, from, to),
  PRECOND: At(p, from) ∧ Plane(p) ∧ Airport(from) ∧ Airport(to)
  EFFECT: - At(p, from) ∧ At(p, to))
```

In such a knowledge base, symbols that describe entities such as cargo (e.g., C1 and C2), airplanes (e.g., P1 and P2), and airports (e.g., JFK and SFP) are stored. Further, symbols that represent a relationship between entities such as cargo, airplanes, and airports (e.g., At and In) or symbols that represent properties of entities (e.g., Cargo and Plane) are stored. Environmental knowledge is described using these symbols. Further, symbols that represent actions of loading and unloading cargo onto airplanes (e.g., Load and Unload) and symbols that represent actions of flying airplanes from one airport to another airport (e.g., Fly) are stored, and pre-conditions and post-conditions of each action are defined (e.g., PRECOND: . . . part and EFFECT: part) using environmental knowledge and stored. Such knowledge is called action knowledge.

Specifically, initial situation (state) knowledge is described in a symbolic logic expression in the form of a conjunction of atomic sentences or literals within parentheses of a sentence “Init ( . . . ),” and a mission (i.e., target state) is described within parentheses of a sentence “Goal ( . . . ).” Three pieces of action knowledge (i.e., action schemas) are described within parentheses of a sentence “Action ( . . . ).” The action schemas may include a list of variables (parameters) representing input arguments (e.g., (c, p, a)), pre-conditions representing knowledge that determines whether a corresponding action may be executed in a specific situation (time point), and post-conditions or effects representing how the state of the environment, i.e., the situation, changes after executing the corresponding action.

Meanwhile, the processor 200 omits (eliminates) a new action node that does not have a causal involvement and does not add the new action node as a sub-node of the current action node. As a result, the processor 200 may rapidly cut off branches that do not lead to the target action node and reduce an increase in the number of front nodes that should be considered in the search tree expansion step.

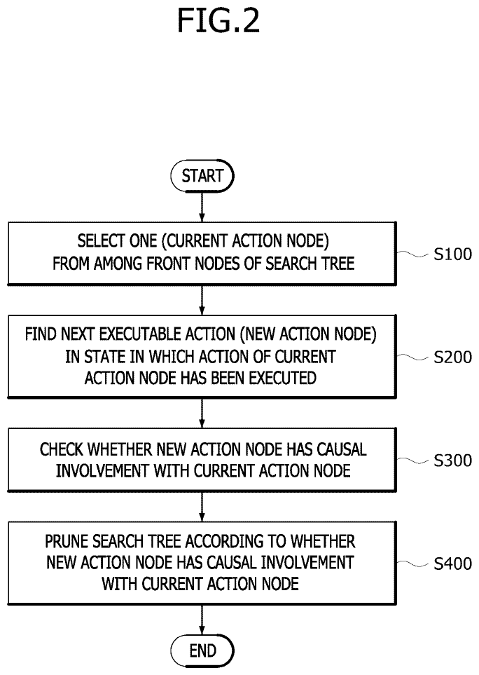

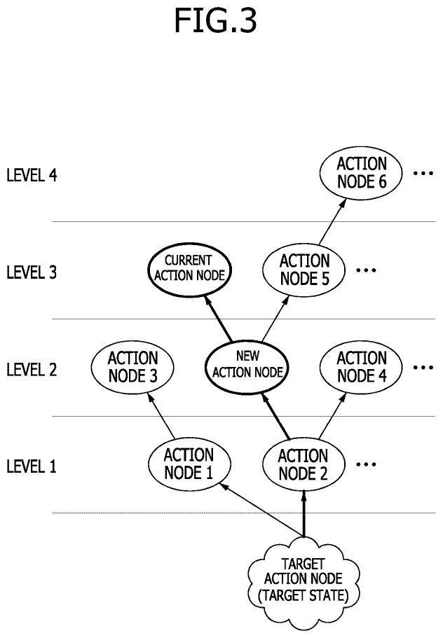

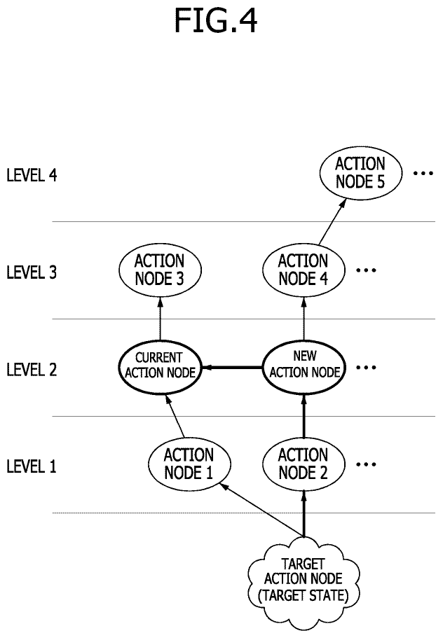

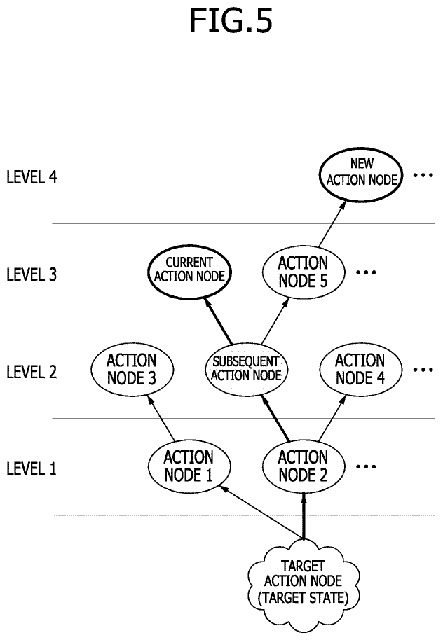

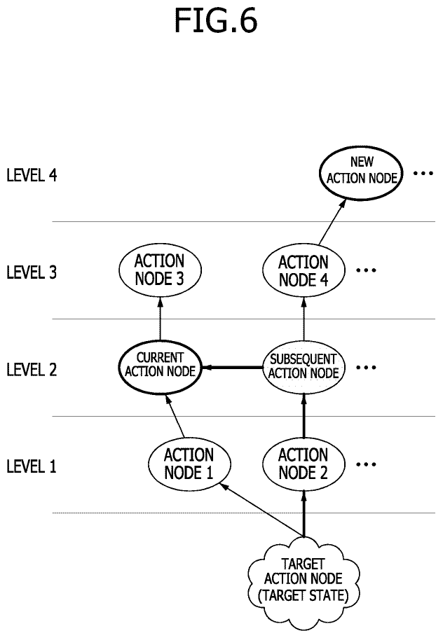

FIG. 2 is a flowchart of a search tree pruning method for an automated planning system according to one embodiment of the present invention, FIG. 3 is a causal action network showing a case in which a new action node has a direct causal relationship with a current action node and is at a level that is one level lower than the current action node according to one embodiment of the present invention, FIG. 4 is a causal action network showing a case in which a new action node has a direct causal relationship with a current action node and is at the same level as the current action node according to one embodiment of the present invention, FIG. 5 is a causal action network showing a case in which a new action node is connected to a subsequent action node at a level that is one level lower than a current action node according to one embodiment of the present invention, and FIG. 6 is a causal action network showing a case in which a new action node is connected to a subsequent action node that is at the same level as a current action node according to one embodiment of the present invention.

Referring to FIG. 2, the processor 200 may check a causal involvement between a new action node and a current action node on the basis of a causal action network.

The processor 200 may select a current action node from among front nodes of a search tree (S100).

The processor 200 may find a next executable action, that is, a new action node, in a state in which an action of the current action node has been executed for expansion (S200).

The processor 200 may check whether the new action node has a causal involvement with the current action node. The processor 200 may determine whether the new action node has a causal involvement with the current action node on the basis of whether the new action node is directly or indirectly connected to a path (a path connected by a bold arrow in FIGS. 3 to 6) through which a target action node is connected to the current action node in the causal action network.

Here, being directly connected may mean that the new action node is a node at a level that is one level lower than the current action node, as illustrated in FIG. 3, or that the new action node is a node that is at the same level as and has a causal relation with the current action node, as illustrated in FIG. 4 (hereinafter referred to as a “subsequent action node”). Accordingly, the processor 200 may determine that the new action node has a causal involvement with the current action node when the new action node is a subsequent action node of the current action node on a path between the current action node and the target action node.

Further, being indirectly connected may mean that the subsequent action node of the current action node is connected to the new action node through another node at a level that is one level higher than the current action node. That is, being indirectly connected may mean that the new action node is connected to the subsequent action node at a level that is one level lower than the current action node, as illustrated in FIG. 5, or that the new action node is connected to the subsequent action node that is at the same level as the current action node, as illustrated in FIG. 6. Accordingly, the processor 200 may determine that the new action node has a causal involvement with the current action node when the new action node is connected to the subsequent action node at a level that is one level lower than the current action node or when the new action node is connected to the subsequent action node that is at the same level as the current action node.

Meanwhile, the processor 200 may prune the search tree by eliminating another new action node and not adding the other new action node as the front node, except in any of the four cases described above, that is, first, when the new action node is directly connected to the current action node and is at a level that is one level lower than the current action node, second, when the new action node is directly connected to the current action node and is at the same level as the current action node, third, when the new action node is connected to a subsequent action node that is at an action level lower than the current action node through another node at a level that is one level higher than the current action node, and fourth, when the new action node is connected to a subsequent action node that is at the same level as the current action node through another node at a level that is one level higher than the current action node, in the causal action network.

The validity of the search tree pruning method may be deduced (inferred) from the following logical facts.

First, in order to reach the target action node from the current action node, the path present in the causal action network should be passed.

Second, the causal relation in the causal action network is a relationship in which only some pre-conditions and post-conditions between two actions match, and thus it is not a complete path, that is, a path that is always established.

Third, when the new action node is not an action node (a subsequent action node) connected to the current action node on the path, the action cannot be executed along the path. This is because the pre-conditions of the subsequent action node are not complete.

Fourth, in order to execute the subsequent action node along the path, among the pre-conditions of the subsequent action node, any insufficient conditions under which the post-conditions of the current action node cannot be provided should be provided by other actions.

Fifth, in order for a new action to provide the insufficient pre-conditions of the subsequent action, the new action should be directly or indirectly connected to the subsequent action.

Sixth, the most efficient path among the paths through which the new action node is connected to the subsequent action node is a path through which the new action node is connected to another node at a level that is one level higher than the subsequent action node.

However, the processor 200 may mitigate the connection conditions between the subsequent action node and the new action node.

In the sixth condition among the above conditions, in addition to the “most efficient path,” some less efficient paths may be included. One such method is to allow the connection path between the new action node and the subsequent action node to include another node that is at the same level as the subsequent action node.

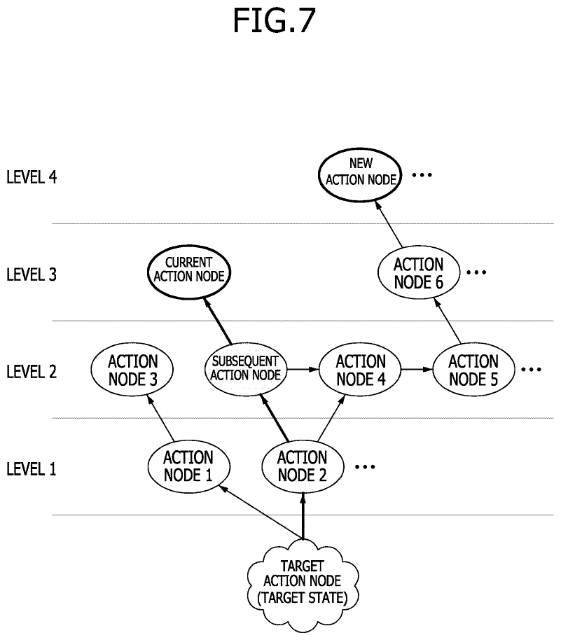

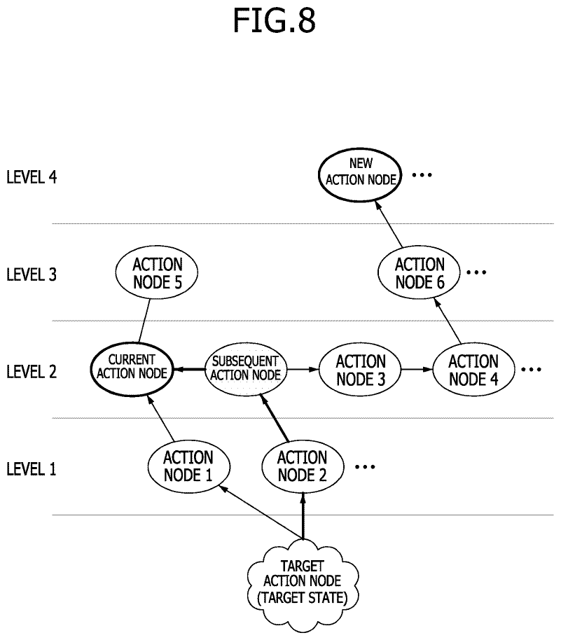

FIG. 7 is a causal action network showing a case in which a subsequent action node is at a level that is one level lower than a current action node and a new action node is connected to the current action node through another node that is at the same level as the subsequent action node according to one embodiment of the present invention, and FIG. 8 is a causal action network showing a case in which a subsequent action node is at the same level as a current action node and a new action node is connected to the current action node through another node that is at the same level as the subsequent action node according to one embodiment of the present invention.

As illustrated in FIGS. 7 and 8, the processor 200 may determine that a new action node has a causal involvement even when the new action node is connected through a node at a level that is one level higher than the new action node after passing through a plurality of other nodes that are at the same level as a subsequent action node.

That is, the processor 200 may determine that a new action node has a causal involvement even when the subsequent action node is connected to the new action node, in the case in which the subsequent action node is at a level that is one level lower than the current action node and the new action node is connected to the current action node through another node that is at the same level as the subsequent action node or in the case in which the subsequent action node is at the same level as the current action node and the new action node is connected to the current action node through another node that is at the same level as the subsequent action node.

In this way, when the condition for the causal involvement between the current action node and the new action node is mitigated, the number of new action nodes that are deleted may be reduced. That is, the effect of search tree pruning may be reduced. However, the pruning conditions that are not mitigated are too harsh, resulting in excessive omission (deletion) of new action nodes, and as a result, there is a need to mitigate the condition for the causal involvement for problems or action plan domains that fail to generate an action plan.

In the present embodiment, as a method of mitigating the condition for the causal involvement between the current action node and the new action node, the processor 200 may set the number of other action nodes that are at the same level as the subsequent action node to be included in the connection path between the subsequent action node and the new action node according to the characteristics of the problem or domain. For example, a case in which it is set to include only one other node that is at the same level as the subsequent action node corresponds to a method of checking the causal involvement before the mitigation illustrated in FIGS. 5 and 6, and a case in which it is set to include two other nodes corresponds to a method of determining a causal involvement, including the cases of FIGS. 7 and 8.

The pseudocode below illustrates a pruned action tree construction algorithm for generating an action plan in an automated planning system. The algorithm begins by constructing a causal action network based on the goal state and knowledge base. It initializes the root of the action tree with a dummy action corresponding to the initial state and incrementally expands the frontier of candidate nodes.

During expansion, the algorithm retrieves executable actions applicable to the current state and checks whether each action has a causal involvement with the current action in the causal network. Only actions satisfying this condition are appended as child nodes, thereby pruning irrelevant branches. If a child node reaches the goal state, the corresponding action plan is extracted. Otherwise, the search continues until the frontier is exhausted or a valid plan is found.

```
# Pseudocode: Pruned Action Tree Construction
Input: KnowledgeBase (KB), InitialState S0, GoalState G
Output: ActionPlan or Failure
1. CausalNetwork ← ConstructCausalActionNetwork(KB, G)
2. Root ← CreateNode(dummy_action, post_condition=S0)
3. Frontier ← [Root]
4. while Frontier is not empty:
  a. Current ← SelectNode(Frontier)
  b. ExecutableActions ← GetApplicableActions(KB, Current.state)
  c. for Action in ExecutableActions:
    i. if HasCausalInvolvement(CausalNetwork, Current.action, Action):
      Child ← CreateNode(Action, parent=Current)
      Frontier.append(Child)
      if Child.state satisfies G:
        return ExtractPlan(Child)
5. return Failure
```

As described above, according to the search tree pruning device and method for an automated planning system according to one embodiment of the present invention, by using a search tree in an action space it is possible to relatively significantly reduce the size of data to be stored and managed. This is because the number of all possible nodes that the search tree should store is the number of all possible actions, and data that should be stored in each node is individual action information, not state information of an entire environment. Since the state of the entire environment is expressed as a logical expression that includes all environment-related knowledge (literal or atomic statements), the number of states may be a maximum number of combinations of multiple pieces of environment knowledge. The actions are distinguished by a difference in pre-conditions and post-conditions and since pre-conditions and post-conditions of one action do not include all knowledge (literal or atomic sentences) of the environment, the maximum number of possible combinations of pre-conditions and post-conditions is less than the number of possible states.

Further, according to the search tree pruning device and method for an automated planning system according to one embodiment of the present invention, by providing a clear and logical model for search tree pruning, it is possible to easily implement a pruning algorithm and apply the pruning algorithm well to actual problems. That is, it can be used to determine whether it is applicable to actual problems or various domains, or to predict and analyze the behavior or performance of an action planning program (search algorithm). For example, it may be determined whether a determination condition for a causal involvement for a given action plan domain or problem is mitigated, and when it is determined that the determination condition for the causal involvement for a given action plan domain or problem is mitigated, it is possible to determine relatively logically how many other nodes that are at the same level as the subsequent action node should be included in a path between the subsequent action node and the new action node, or it is possible to determine it relatively accurately by solving a few small problems and observing the behavior of the program (success or failure, generation time, number of searched and generated nodes, number of deleted (missed) nodes, etc.).

Further, according to the search tree pruning device and method for an automated planning system according to one embodiment of the present invention, it is possible to rapidly generate an action plan. A speed of generating the action plan is an important factor in the performance of an automatic action planning system (program), and the speed of generating the action plan depends on the size of a search space. All heuristic search-based automatic action planning systems may apply various heuristics to reduce the search space.

According to the search tree pruning device and method for an automated planning system according to one aspect of the present invention, by constructing a search tree in an action space and pruning the search tree according to a causal involvement between actions when expanding the search tree, it is possible to reduce a search space and rapidly generate an action plan.

According to the search tree pruning device and method for an automated planning system according to one aspect of the present invention, by using a search tree in an action space, it is possible to significantly reduce the size of data that needs to be stored and managed.

According to the search tree pruning device and method for an automated planning system according to one aspect of the present invention, by providing a clear and logical model for search tree pruning, it is possible to easily implement pruning algorithms and apply the pruning algorithms to real-world problems.

The present invention may be deployed in physical autonomous agents such as warehouse robots, drones, or autonomous vehicles. In such systems, planning time directly affects battery usage, mission success rate, and system safety. By applying causal-involvement-based pruning in the action space, the number of candidate actions evaluated per step is significantly reduced, resulting in faster plan generation and lower computational overhead.

In one embodiment, the planning module is embedded in an on-board computing unit (e.g., SoC with AI acceleration). The pruning logic operates in real time with sensor input, ensuring that only causally meaningful actions are evaluated within a time window (e.g., <50 ms), enabling high-frequency decision making in dynamic environments.

In contrast to conventional planners that construct search trees in the state space, the present invention operates within the action space, representing each node as an action rather than a world state. This distinction allows the use of causal action networks, which are hierarchically constructed using symbolic knowledge, to proactively eliminate irrelevant actions.

For example, FF-Planner and FastDownward planners apply heuristic state evaluation to guide search. However, they do not prune action candidates based on domain-specific causal structures, and they rely on costly heuristic functions for each state. Our approach performs lightweight structural pruning based on precomputed relationships, leading to 30-50% fewer generated nodes and reduced memory footprint in benchmark domains.

While the present invention has been described with reference to embodiments illustrated in the accompanying drawings, the embodiments should be considered in a descriptive sense only, and it should be understood by those skilled in the art that various alterations and other equivalent embodiments may be made. Therefore, the scope of the present invention should be defined by only the following claims.

What is claimed is:

1. A search tree pruning device for an automated planning system, comprising:
a processor; and
a memory configured to store instructions executed by the processor,
wherein the processor selects a current action node from among front nodes of a search tree in an action space to execute an action of the current action node and adds a new action node as a sub-node of the current action node according to whether the new action node has a preset causal involvement with the current action node.

2. The search tree pruning device of claim 1, wherein the processor selects one of the front nodes of the search tree to execute an action, finds a new executable action node in a state in which the action of the current action node is executed, adds the new executable action node as the sub-node of the current action node, and checks whether the state in which the action of the added new action node is executed is a target state to generate the search tree.

3. The search tree pruning device of claim 1, wherein the processor determines the causal involvement between the current action node and the new action node on a causal action network.

4. The search tree pruning device of claim 3, wherein a hierarchical structure of the causal action network is formed in such a way that actions that have a causal relation with actions belonging to one layer form a next layer.

5. The search tree pruning device of claim 3, wherein the processor writes the causal action network using actions that are instantiated by substituting symbols representing entity knowledge stored in a knowledge base for variables of action schemas.

6. The search tree pruning device of claim 3, wherein the processor determines whether the new action node has a causal involvement with the current action node on the basis of whether the new action node is directly or indirectly connected to a path through which the target action node is connected to the current action node in the causal action network.

7. The search tree pruning device of claim 6, wherein the processor determines that the new action node has a causal involvement with the current action node when the new action node is at a level that is one level lower than or the same level as the current action node and the new action node is a node subsequent to the current action node on the path between the current action node and the target action node.

8. The search tree pruning device of claim 6, wherein the processor determines that the new action node has a causal involvement with the current action node when the new action node is connected to a subsequent action node at a level that is one level lower than the current action node or when the new action node is connected to a subsequent action node that is at the same level as the current action node.

9. The search tree pruning device of claim 6, wherein the processor determines that the new action node has a causal involvement with the current action node when the subsequent action node is at a level that is one level lower than the current action node and the new action node is connected to the current action node through another action node that is at the same level as the subsequent action node, or when the subsequent action node is at the same level as the current action node and the new action node is connected to the current action node through another node that is at the same level as the subsequent action node.

10. A search tree pruning method for an automated planning system, comprising:
selecting, by a processor, a current action node from among front nodes of a search tree in an action space to execute an action of the current action node, and determining whether a new action node has a preset causal involvement with the current action node; and
adding, by the processor, the new action node as a sub-node of the current action node according to a result of the determination.

11. The search tree pruning method of claim 10, wherein, in the determining whether the new action node has the causal involvement with the current action node, the processor selects one of the front nodes of the search tree to execute an action, finds a new executable action node in a state in which the action of the current action node is executed, adds the new executable action node as the sub-node of the current action node, and checks whether the state in which the action of the added new action node is executed is a target state to generate the search tree.

12. The search tree pruning method of claim 10, wherein, in the determining whether the new action node has the causal involvement with the current action node, the processor determines the causal involvement between the current action node and the new action node on a causal action network.

13. The search tree pruning method of claim 12, wherein a hierarchical structure of the causal action network is formed in such a way that actions that have a causal relation with actions belonging to one layer form a next layer.

14. The search tree pruning method of claim 12, wherein, in the determining whether the new action node has the causal involvement with the current action node, the processor writes the causal action network using actions that are instantiated by substituting symbols representing entity knowledge stored in a knowledge base for variables of action schemas.

15. The search tree pruning method of claim 12, wherein, in the determining whether the new action node has the causal involvement with the current action node, the processor determines whether the new action node has a causal involvement with the current action node on the basis of whether the new action node is directly or indirectly connected to a path through which the target action node is connected to the current action node in the causal action network.

16. The search tree pruning method of claim 15, wherein, in the determining whether the new action node has the causal involvement with the current action node, the processor determines that the new action node has a causal involvement with the current action node when the new action node is at a level that is one level lower than or the same level as the current action node and the new action node is a node subsequent to the current action node on the path between the current action node and the target action node.

17. The search tree pruning method of claim 15, wherein, in the determining whether the new action node has the causal involvement with the current action node, the processor determines that the new action node has a causal involvement with the current action node when the new action node is connected to a subsequent action node at a level that is one level lower than the current action node or when the new action node is connected to a subsequent action node that is at the same level as the current action node.

18. The search tree pruning method of claim 15, wherein, in the determining whether the new action node has the causal involvement with the current action node, the processor determines that the new action node has a causal involvement with the current action node when the subsequent action node is at a level that is one level lower than the current action node and the new action node is connected to the current action node through another action node that is at the same level as the subsequent action node, or when the subsequent action node is at the same level as the current action node and the new action node is connected to the current action node through another node that is at the same level as the subsequent action node.
